(19) United States
(12) Patent Application Publication
(10) Pub. No.: US 2018/0115394 A1
(43) Pub. Date: Apr. 26, 2018

(54) USER TERMINAL, RADIO BASE STATION AND RADIO COMMUNICATION METHOD

(71) Applicant: NTT DOCOMO, INC., Tokyo (JP)

(72) Inventors: Hiroki Harada, Tokyo (JP); Satoshi Nagata, Tokyo (JP); Lihui Wang, Beijing (CN); Liu Liu, Beijing (CN); Huiling Jiang, Beijing (CN)

(73) Assignee: NTT DOCOMO, INC., Tokyo (JP)

(21) Appl. No.: 15/564,765

(22) PCT Filed: Apr. 8, 2016
(86) PCT No.: PCT/JP2016/061501

§ 371 Date: Oct. 6, 2017

(30) Foreign Application Priority Data
Apr. 9, 2015 (JP) 2015-080326

(51) Int. Cl. H04L 1/18; H04W 72/04

(52) U.S. Cl. CPC H04L 1/1861; H04W 72/042

(57) ABSTRACT

The present invention is designed to optimize the retransmission control when communication is carried out by using a plurality of cells. A radio base station (10) transmits transmission data to a user terminal (20), the radio base station transmits command information for controlling a receiving process of the user terminal, to the user terminal, by using an HARQ process, and transmits retransmission data of the transmission data in licensed carrier, among a plurality of cells, which is different from an unlicensed cell that has been used to transmit the transmission data, and the user terminal receives the retransmission data in the licensed carrier in accordance with the command information from the radio base station.

### TECHNICAL FIELD

The present invention relates to a user terminal, a radio base station and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). Also, successor systems of LTE (also referred to as, for example, “LTE-advanced” (hereinafter referred to as “LTE-A”), “FRA” (Future Radio Access) and so on) are under study for the purpose of achieving further broadbandization and increased speed beyond LTE.

Furthermore, in relationship to future radio communication systems (Rel. 13 and later versions), a system (“LTE-U” (LTE Unlicensed)) to run an LTE system not only in frequency bands that are licensed to communications providers (operators) (licensed bands), but also in frequency bands that do not require license (unlicensed bands), is under study.

While a licensed band refers to a band in which a specific operator is allowed exclusive use, an unlicensed band (also referred to as a “non-licensed band”) refers to a band which is not limited to a specific operator and in which radio stations can be provided. For unlicensed bands, for example, the 2.4 GHz band and the 5 GHz band where Wi-Fi and Bluetooth (registered trademark) can be used, and the 60 GHz band where millimeter-wave radars can be used are under study for use.

In LTE-U operation, a mode that is premised upon coordination with licensed band LTE is referred to as “LAA” (Licensed-Assisted Access), “LAA-LTE” and so on. Note that systems that run LTE/LTE-A in unlicensed bands may be collectively referred to as “LAA,” “LTE-U,” “U-LTE,” and so on.

For unlicensed bands in which LAA is run, a study is in progress to introduce interference control functionality in order to allow co-presence with other operators' LTE, Wi-Fi or different systems. In Wi-Fi, LBT (Listen Before Talk), which is based on CCA (Clear Channel Assessment), is used as an interference control function within the same frequency. In Japan and Europe, the LBT function is stipulated as mandatory in systems that are run in the 5 GHz unlicensed band such as Wi-Fi.

### CITATION LIST

### Non-Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall Description; Stage 2”

### SUMMARY OF INVENTION

### Technical Problem

Now, in LAA in which an unlicensed carrier is used, if the unlicensed carrier is detected to be in the busy state by means of LBT, the delay it takes the transmission data that is transmitted for the first time in the unlicensed carrier before it is retransmitted becomes longer. Consequently, there is a possibility that the receipt of the retransmission data by user terminals in the unlicensed carrier is also delayed, and the management of soft buffer by user terminals becomes inefficient. Also, even when a system does not use an unlicensed carrier, if communication is carried out by using a plurality of carriers (cells), there is still a demand for flexible retransmission control that takes the load balance among multiple carriers.

The present invention has been made in view of the above, and it is therefore an object of the present invention to provide a user terminal, radio base station and radio communication method that support optimal retransmission control when communication is carried out by using a plurality of cells.

### Solution to Problem

The user terminal of the present invention can communicate with a radio base station by using a plurality of cells, and has a receiving section that receives transmission data from the radio base station, and a control section that controls a receiving process in the receiving section based on a command that is reported from the radio base station by using an HARQ (Hybrid Automatic Repeat reQuest) process, and, in this user terminal, among the plurality of cells, the control section controls the receiving section to use a second cell, which is different from a first cell that has been used to transmit the transmission data from the radio base station, to receive retransmission data of the transmission data.

### Advantageous Effects of Invention

According to the present invention, even when the state in which transmission data cannot be retransmitted ensues in a first cell, retransmission data of this transmission data can be received in a second cell apart from the first cell, so that the time delay it takes to receive retransmission data can be reduced. Also, since retransmission data is received fast, it is no longer no necessary to keep transmission data in user terminals' soft buffers, so that it is possible to use soft buffers efficiently, and, furthermore, reduce the power consumption.

### BRIEF DESCRIPTION OF DRAWINGS

FIG. 1 is a diagram to explain examples of LBT in LAA;

FIG. 2 is a diagram to explain an example of retransmission delay in an LAA unlicensed carrier;

FIG. 3 is a diagram to explain an example of cross-carrier retransmission on the downlink;

FIG. 4 provide diagrams show examples of first retransmission control;

FIG. 5 provide diagrams to show examples of option 1 in second retransmission control;

FIG. 6 provide diagrams to show examples of option 2 in second retransmission control;

FIG. 7 provide diagrams to show examples of option 3 in second retransmission control;

FIG. 8 provide diagrams to show examples of option 4 in second retransmission control;

FIG. 9 is a diagram to show an example of a schematic structure of a radio communication system according to the present embodiment;

FIG. 10 is a diagram to show an example of an overall structure of a radio base station according to the present embodiment;

FIG. 11 is a diagram to show an example of a functional structure of a radio base station according to the present embodiment;

FIG. 12 is a diagram to show an example of an overall structure of a user terminal according to the present embodiment; and

FIG. 13 is a diagram to show an example of a functional structure of a user terminal according to the present embodiment.

### DESCRIPTION OF EMBODIMENTS

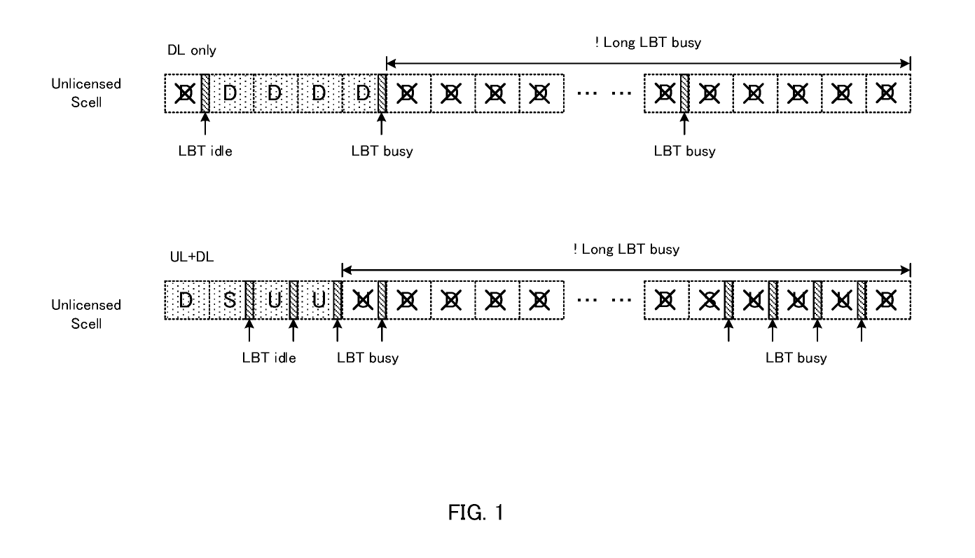

FIG. 1 is a diagram to explain examples of LBT (Listen Before Talk) in LAA (Licensed-Assisted Access). In Rel-13 LAA, for example, interference reduction that is based on LBT functions is carried out in unlicensed carriers in order to allow co-presence with other operators' LTE, Wi-Fi or other systems. In LBT, a transmission point (for example, a radio base station and/or a user terminal) performs “listening” before transmitting signals, to see whether or not signals to exceed a predetermined level (for example, predetermined power) are being transmitted from other transmission points. Note that, listening may be referred to as “LBT,” “CCA” (Clear Channel Assessment), “carrier sensing” and so on.

As LBT schemes, FBE (Frame Based Equipment) and LBE (Load Based Equipment) are currently under study. Differences between these include that, while FBE operates in fixed (periodic) timings, in LBE, listening continues until a channel is available. To be more specific, FBE refers to the mechanism of making transmission if the result of listening shows that a channel is available for use, and waiting until the next timing if no channel is available for use. By contrast, LBE refers to the mechanism of extending the listening time is the result of carrier sensing shows that no channel is available for use, and continues executing listening until a channel is available. In LBE, random backoff is required to avoid contention adequately.

An unlicensed carrier may be used for DL communication only, as shown in the upper diagram in FIG. 1, or an unlicensed carrier may be used for DL/UL communication, as shown in the lower diagram in FIG. 1. Although, in a secondary cell of the DL communication-only unlicensed carrier, presuming FBE, listening is carried out every four subframes, downlink communication cannot be resumed while the channel busy state (LBT-Busy) continues. Similarly, in a secondary cell of the DL/UL communication unlicensed carrier, too, listening is executed in both the radio base station and user terminals, but uplink communication and downlink communication cannot be resumed while the channel busy state continues. Note that although FBE to execute listening every four subframes is shown here, the same problem arises when LBE is used.

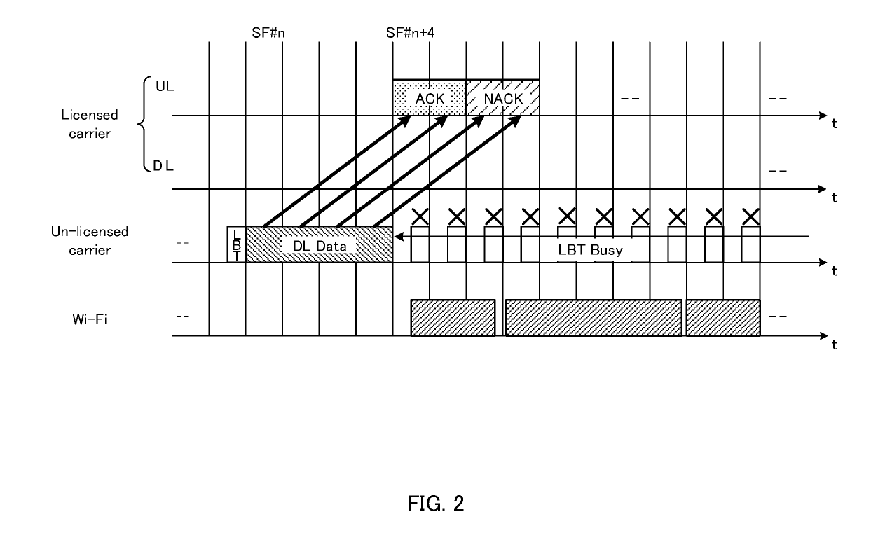

As shown in FIG. 2, when downlink transmission data is transmitted by using an unlicensed carrier, an ACK (ACKnowledgement) or a NACK (Negative ACKnowledgement) is returned from the receiving end in a licensed carrier. In this case, if the unlicensed carrier is used in Wi-Fi and the channel busy state continues long, the transmission data cannot be retransmitted in the unlicensed carrier. Consequently, the delay before the transmission data is transmitted becomes long, and the throughput decreases. Furthermore, there is a problem that the transmission data of the initial transmission needs to be kept in user terminals' soft buffers for HARQ (Hybrid Automatic Repeat reQuest) processes, so that the management of soft buffers becomes inefficient, and the power consumption increases.

If HARQ retransmission is not possible, RLC layer retransmission control is applied. Although control in the MAC layer or lower layers such as HARQ control varies per carrier, in RLC layer retransmission control, it is possible to use carriers that are different from the carriers that have been used up till then. However, in RLC control, when a missing data packet is detected in the RLC layer of the receiving end, the RLC timer (Reordering Timer) is started and RLC retransmission is triggered after the timer expires, and therefore the delay time is generally long. Also, since, in RLC retransmission, data packets that have failed to be transmitted are retransmitted to user terminals as new transmission data, these data packets cannot be combined with the transmission data before the RLC retransmission on the terminal end, and therefore gain cannot be achieved, unlike with HARQ. Furthermore, there is a problem that, until RLC retransmission triggered, the transmission data before the RLC retransmission needs to be kept in user terminals' soft buffers.

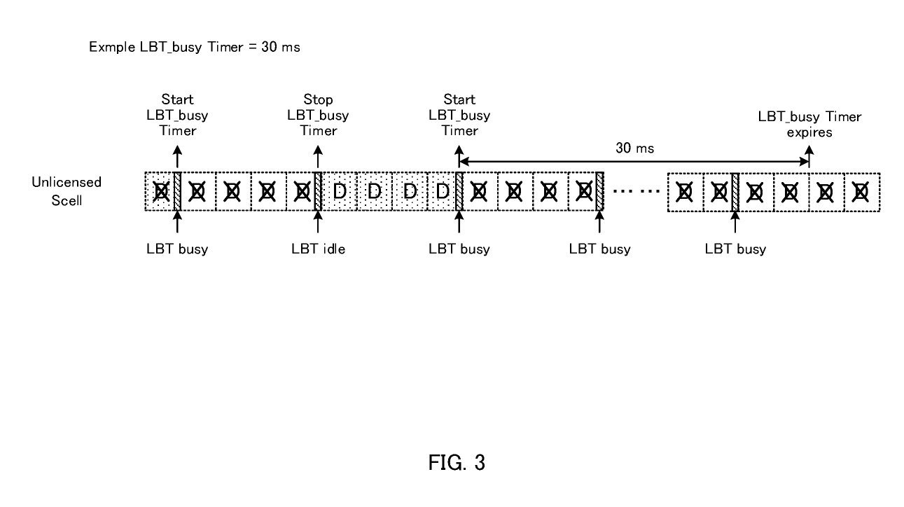

So, as shown in FIG. 3, when, in FBE or LBE, a radio base station's transmission buffer is not empty and the channel is judged to be in the busy state, it may be possible to start an LBT busy timer (LBT_Busy Timer) and trigger data retransmission in another carrier after the LBT busy timer expires. By configuring the LBT busy timer shorter than the RLC timer (Reordering Timer), it is possible to reduce the retransmission delay. The LBT busy timer may be configured to stop if transmission succeeds while the timer is running, and expire when a predetermined period passes without transmission even though the transmission buffer is not empty. Note that a value (for example, 30 ms) that is arbitrarily configured by the radio base station may be set on the LBT busy timer. Also, the retransmission data may be referred to as “unsuccessful data.”

The present inventors have focused on the possibility that retransmission delay may be produced when the same cell (carrier) is used in the initial transmission and in retransmission, and come up with an optimal control method for cross-carrier retransmission that uses other cells. Now, the retransmission control of the present invention will be described below. Although scenarios to use licensed carriers and unlicensed carriers will be described to illustrate systems that use a plurality of cells, such configurations are by no means limiting. A plurality of cells may be a plurality of licensed carriers or may be a plurality of unlicensed carriers. Consequently, systems that include carriers where LBT is not configured are also applicable. Also, to a plurality of carriers, carrier aggregation (CA) may be applied, or dual connectivity (DC) may be applied. Note that a cell may be referred to as a “carrier,” or may be referred to as a “component carrier (CC).”

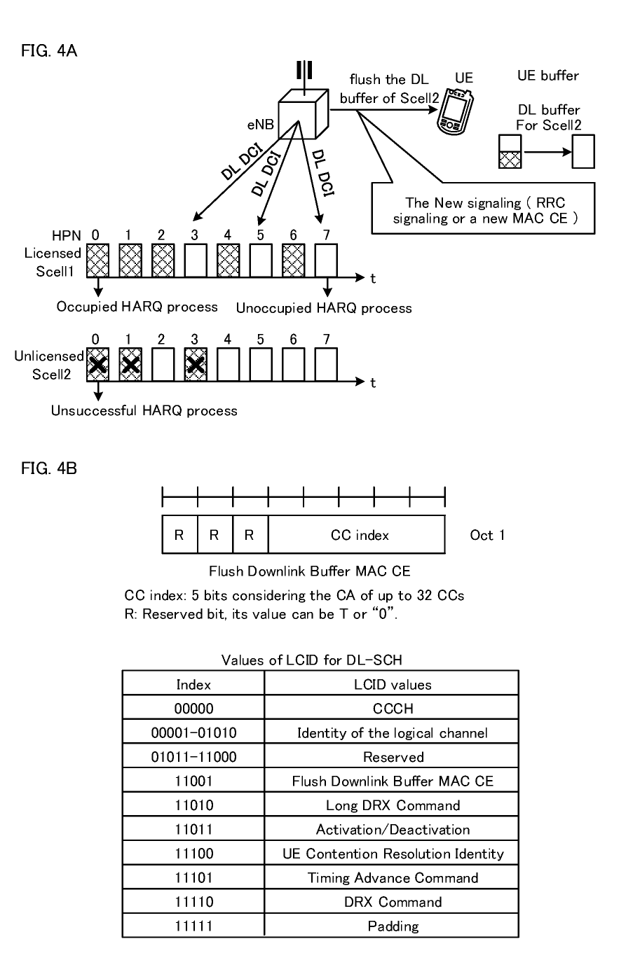

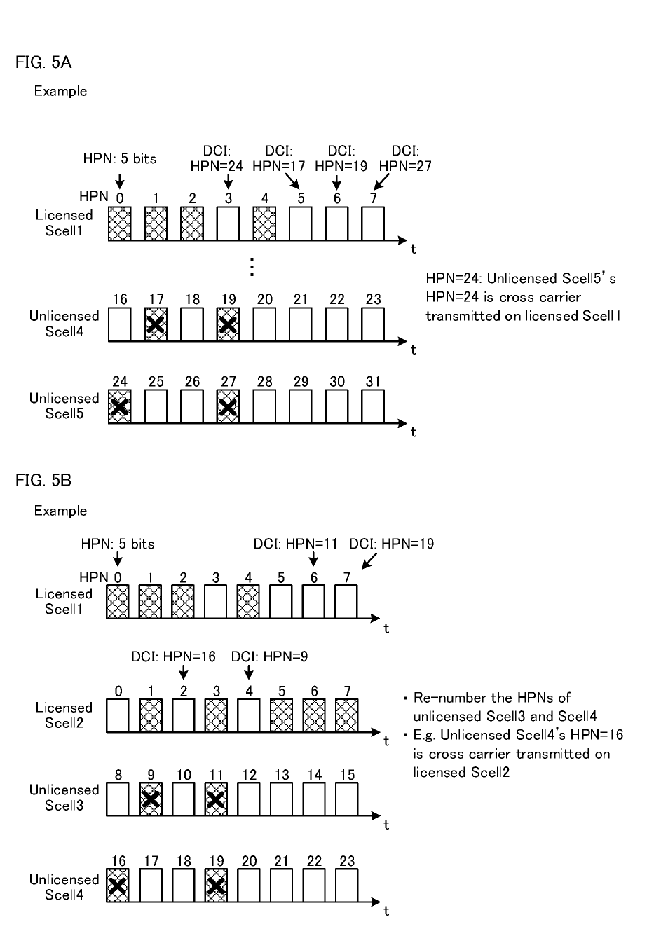

Now, a cross-carrier retransmission control method will be described below with reference to FIG. 4 to FIG. 8. FIG. 4 provide diagrams to show examples of first retransmission control. FIG. 5 to FIG. 8 provide diagrams to show options 1 to 4 in second retransmission control, respectively. Although the unlicensed carriers in the following description will refer to first cells to be used for the initial transmission, and the licensed carriers will refer to second cells to be used for retransmission, this configuration is by no means limiting. The first cells have only to be cells for use for the initial transmission of transmission data, and the second cells have only to be cells for use for transmitting retransmission data. Also, although examples will be described below in which licensed carriers and unlicensed carriers are used as secondary cells (“secondary cells,” “SCells,” etc.), it is possible to use a licensed carrier as the primary cell (“primary cell,” “PCell,” etc.). Also, for ease of explanation, a secondary cell of a licensed carrier will be referred to as a “licensed SCell,” and a secondary cell of an unlicensed carrier will be referred to as an “unlicensed SCell.”

Referring to FIG. 4A, in the first retransmission control, when, for example, the LBT busy timer expires before a data packet is successfully transmitted and the base station judges that retransmission should be made in another carrier, the radio base station transmits the unsuccessful data to the user terminal as new transmission data in another carrier. That is, in the user terminal, the unsuccessful data is received as new data in a carrier that is different from the carrier that was used in the initial transmission. In this case, it is possible to reduce the delay before retransmission is sent, by, for example, setting the expiration time of the LBT busy timer shorter than that of the RLC timer. Since new data is transmitted from the radio base station to the user terminal, if the past data that is held in the user terminal's soft buffers can be deleted (flushed) in a timely fashion, it is possible to improve the efficiency of the use of the soft buffers, and reduce the user terminal's power consumption. Note that new transmission data may be referred to as “new data.”

The user terminal manages the received data in the soft buffers based on carrier indices and HPNs (HARQ Process Numbers) 0 to 7, which are carrier-specific retransmission control process numbers. For example, if the LBT busy timer expires while received data is stored in the soft buffers of unlicensed SCell 2 that correspond to HPNs 0, 1 and 3, in this unlicensed SCell 2, efficient retransmission cannot be expected for a while, and therefore the data in the soft buffers of this unlicensed SCell 2 linked with HPNs 0, 1 and 3 is given up, and the unsuccessful data is transmitted as new data in HPNs 3, 5 and 7 of licensed SCell 1.

In this case, according to the first retransmission control of the present invention, new signaling is introduced to flush the past data that is held in the user terminal's soft buffers, as shown in FIG. 4B. To be more specific, by this new signaling, carrier indices are reported as flush information for flushing data from soft buffers on a per carrier basis. The carrier indices may be reported via higher layer signaling (RRC signaling), or may be defined anew by using MAC CEs (Medium Access Control Control Elements). When the carrier indices are reported using MAC CEs, it is possible to indicate that these indices are information to command flushing of soft buffers, by using logical channel identifiers (LCIDs: Logical Channel IDs). Also, although the flush information may be, for example, indicated in five bits so as to designate maximum 32 carriers, the number of bits is no particularly limited. Furthermore, HPNs may be reported, in addition to carrier indices, as flush information.

As shown in FIG. 5 to FIG. 8, in the second retransmission control, when, for example, the LBT busy timer expires before a data packet is successfully transmitted and the base station judges that retransmission should be made in another carrier, the radio base station transmits retransmission data to the user terminal as continuing data of unsuccessful data. The second retransmission control is different from the first retransmission control in that data that is transmitted in a given carrier and held in soft buffers and the continuing data of this data that is transmitted in another carrier are combined in soft buffers. In this case, the user terminal has to recognize that data that has been received in the past and its continuing data, which is going to be received from now, are a common HARQ process. Note that continuing data may be referred to as “old data.”

As shown in FIG. 5A, in option 1 of the second retransmission control, continuous HPNs are configured in a plurality of carriers. By assigning serial HPNs between a plurality of carriers, different HPNs are configured in all of the HARQ processes of these multiple carriers. Consequently, when continuing data (retransmission data) is transmitted in DCI (Downlink Control Information), the HPNs of the past transmission data to be combined with this continuing data are reported, so that it is possible to combine the past transmission data and the continuing data in soft buffers without worrying in which carriers the data has been transmitted.

For example, the receiving process has failed in HPNs 17 and 19 of unlicensed SCell 4 and in HPNs 24 and 27 of unlicensed SCell 5, and the past transmission data is stored in the corresponding soft buffers. In this case, HPNs 17, 19, 24 and 27 are reported to the user terminal in DCI when continuing data is transmitted in licensed SCell 1, so that the continuing data transmitted in licensed SCell 1 and the data that has been transmitted in the past in another carrier and are now stored in HPNs 17, 19, 24 and 27 are combined in the soft buffers. By thus using continuous HPNs between pluralities of carriers, it is possible to link between past transmission data and continuing data by using HPNs. Note that the HPNs are not limited to five bits, and the number of bits can be changed depending on the number of carriers.

Also, as shown in FIG. 5B, it is possible to configure the numbers of HPNs 0 to 7 in carriers that are used to transmit continuing data, and apply serial numbers starting from HPN 8 to carriers that are used for the initial transmission. For example, HPNs 0 to 7 are configured in each of licensed SCells 1 and 2, and serial numbers that start from HPN 8 are configured in unlicensed SCells 3 and 4. Even when this structure is used, if, for example, continuing data is transmitted in one of the licensed carriers and an HPNs that are equal to or greater than HPN 8 are reported, it is possible to combine past transmission data and the continuing data in soft buffers. By employing this configuration, it is possible to apply cross-carrier transmission to a wider range of targets.

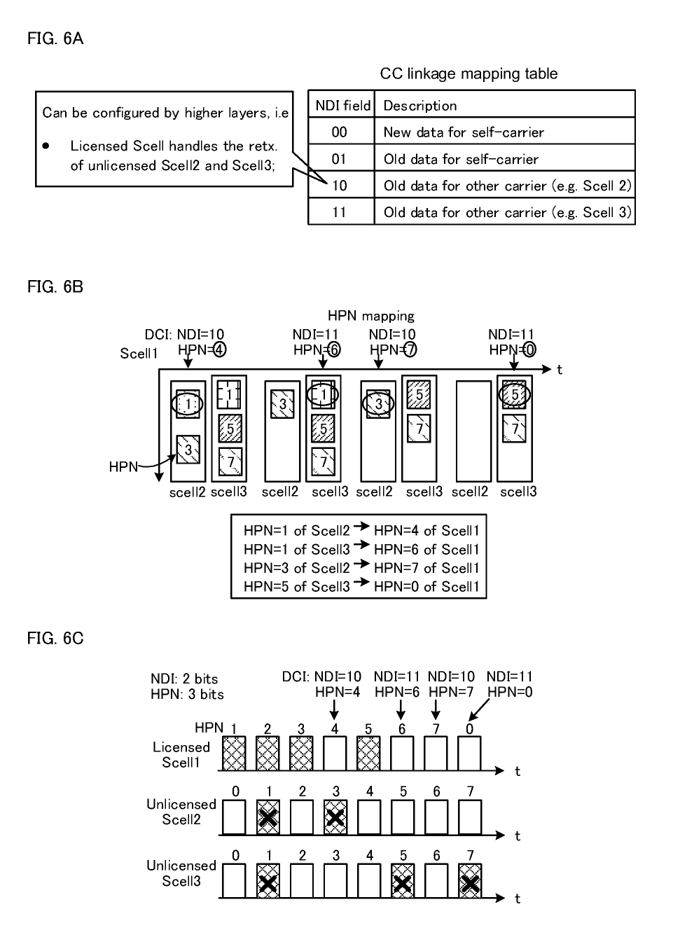

As shown in FIG. 6A, option 2 of the second retransmission control is designed so that indicator bits, which are provided in the NDI (New Data Indicator) field of DCI expanded to two bits, distinguish between new transmission data and continuing data, and, furthermore, identify the carrier that has been used in the past to transmit the data to which continuing data corresponds. By this means, it is possible to allow a user terminal to recognize whether retransmission data is new transmission data or continuing data, without assigning continuous HPNs to a plurality of carriers, and, furthermore, to recognize whether or not continuing data is cross-carrier-retransmitted. Note that, maximum two carriers to use for the initial transmission can be designated in advance in the NDI field by using higher layer signaling (RRC signaling) and so on.

For example, the indicator bits “00” in the NDI field indicate new transmission data to be transmitted in the self-carrier. The indicator bits “01” in the NDI field indicate continuing data of data that has been transmitted in the past in the self-carrier. The indicator bits “10” in the NDI field indicate continuing data of data that has been transmitted in the past in another carrier (for example, SCell 2). The indicator bits “11” in the NDI field indicate continuing data of data that has been transmitted in the past in yet another carrier (for example, SCell 3). Note that the structure to report the indicator bits in the NDI field is by no means limiting, and the indicator bits may be reported using any method as long as they can be reported to user terminals. Also, the number of NDI indicator bits is not limited to two bits, and the number of HPN bits is not limited to three bits either.

Although these NDI indicator bits can designate cross-carrier retransmission, given that HPNs 0 to 7 are used in a plurality of carriers, it is still necessary to make a user terminal identify which HARQ process in the designated carrier continuing data corresponds to. So, as shown in FIG. 6B, based on specific rules, an HPN of a carrier in which transmission has been made in the past but resulted in a failure of receipt may be mapped to an HPN of a carrier that can be used in cross-carrier retransmission. For example, if “10” or “11” is reported in the NDI field in the DCI of a carrier that can be used for cross-carrier retransmission, among the HPNs of the carrier designated in the NDI field, the smallest number is mapped to the HPN that is designated in this DCI. In this way, it is possible to allow a user terminal to recognize the relationship between past transmission data and retransmission data, in an indirect way, without explicitly reporting the relationship in mapping to the user terminal.

For example, when HPNs 4, 6, 7 and 0, which are not used in licensed SCell 1, are reported with NDI fields 10, 11, 10 and 11, in this order, HPN 1 of unlicensed SCell 2, HPN 1 of unlicensed SCell 3, HPN 3 of unlicensed SCell 2 and HPN 5 of unlicensed SCell 3 are mapped, respectively. In this way, it is possible to allocate an unlicensed carrier's HPNs, designated in NDI fields, from the smallest HPN, preferentially, to unoccupied HPNs of licensed SCell 1. HPN 7 of unlicensed SCell 3 is held in the soft buffer until a licensed SCell is available.

By combining this mapping of HPNs with the NDI indicator bits described above, it is possible to use unoccupied HPNs of licensed SCell 1 for the retransmission data of the HPNs of unlicensed SCells 2 and 3. By using HPNs that are unoccupied in licensed SCell 1, it is possible to close the soft buffers of unlicensed SCells 2 and 3, and reduce the power consumption. Note that the method of mapping has only to be a method that allows a user terminal to implicitly recognize the relationship in mapping. For example, it is possible to map the largest number among the HPNs of the carriers designated in the NDI field, to the HPN that is reported with the NDI.

As shown in FIG. 6C, when continuing data is transmitted in HPN 4 of licensed SCell 1, if the NDI indicator bits “10” are reported in DCI, a user terminal recognizes that this data is continuing data of unlicensed SCell 2. Also, based on the above-described existing rules, the user terminal recognizes that HPN 1 is mapped, which is the smallest HPN in unlicensed SCell 2. Consequently, it is possible to empty the soft buffer that is secured for HPN 1 of unlicensed SCell 2, and move the data stored therein to the soft buffer secured for HPN 4 of licensed SCell 1. Consequently, in HPN 4 of licensed SCell 1, continuing data and past transmission data are combined in the soft buffer.

Similarly, when continuing data other carriers is transmitted by using HPNs 6, 7 and 0 of licensed SCell 1, the NDI indicator bits “11,” “10” and “11” are reported in DCI, so that the user terminal recognizes that these are all continuing data of unlicensed SCell 2 or unlicensed SCell 3. If the data stored in the soft buffers corresponding to unlicensed SCell 2 and unlicensed SCell 3 can be moved to the soft buffers corresponding to licensed SCell 1, it is possible to close the soft buffers of unlicensed SCells 2 and 3 and reduce the power consumption.

Alternatively, it is also possible to retain the data stored in the soft buffers of carriers that cannot be used for retransmission (carriers that are used in the initial transmission), on an as-is basis, without mapping HPNs. In this case, for example, when retransmission data is transmitted, NDI indicator bits and an HPN of a carrier that cannot make retransmission are reported. The NDI indicator bits can identify to which carrier cross-carrier retransmission corresponds to, so that the HPN that has been used in the carrier where retransmission cannot be made has to be used on an as-is basis. For example, when retransmission data of HPN 1 of unlicensed SCell 2 is transmitted in licensed SCell 1, NDI indicator bits “10” and HPN 1 are reported in DCI. Also, when retransmission data of HPN 5 of unlicensed SCell 3 are transmitted in licensed SCell 1, NDI indicator bits “11” and HPN 5 are reported in DCI. By employing this configuration, the number of HARQ processes that are capable of cross-carrier retransmission is not limited to the number of processes that are unoccupied in carriers that are capable of cross-carrier retransmission.

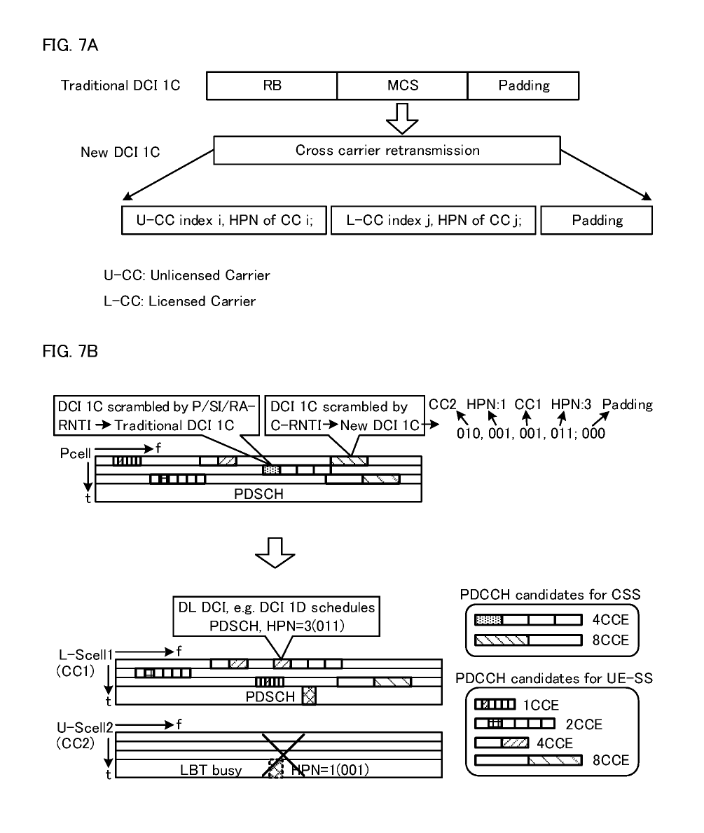

As shown in FIG. 7A, in option 3 of the second retransmission control, combinations of carrier indices and HPNs are reported by using DCI format 1C, which is transmitted in the common search space of the PCell. In the common search space of a downlink control channel, a user terminal performs blind decoding per DCI format having a different length, descrambles the CRCs with different RNTIs (Radio Network Temporary Identifiers), and picks up the information that is needed. Here, it is possible to define new user-specific RNTI for DCI format 1C and transmit new information. C-RNTIs (Cell-Radio Network Temporary Identifiers), which are not set forth in DCI format 1C, may be used as user-specific RNTIs.

When user-specific RNTIs are set forth in DCI format 1C, it is necessary to designate the combination of the reference-source carrier in cross-carrier communication and an HPN, and the combination of the referring carrier and an HPN, per user terminal. That is, in DCI, the combination of the carrier index of the carrier that transmits the initial transmission data, and an HPN, and the combination of the carrier index of the carrier that transmits continuing data, and an HPN, are included. Note that the combinations of carrier indices and HPNs are not limited to the configuration to be reported in DCI format 1C, and may be reported to user terminals in other schemes.

As shown in FIG. 7B, for example, continuing data of transmission data of HPN 1 of unlicensed SCell 2 is retransmitted in HPN 3 of licensed SCell 1. In this case, DCI format 1C, which has been scrambled by an C-RNTI and so on, is descrambled by a user terminal's C-RNTI, and recognized by the user terminal as new DCI format 1C. By this means, the user terminal identifies the combination of “010” and “001,” which represent reference-source unlicensed SCell 2 and HPN 1, and the combination of “001” and “011,” which represent referring licensed SCell 1 and HPN 3. After this, the user terminal can recognize the retransmission data of the referring carrier's HPN as continuing data of the transmission data of the reference-source carrier's HPN, and combines the continuing data and the past transmission data in the soft buffer.

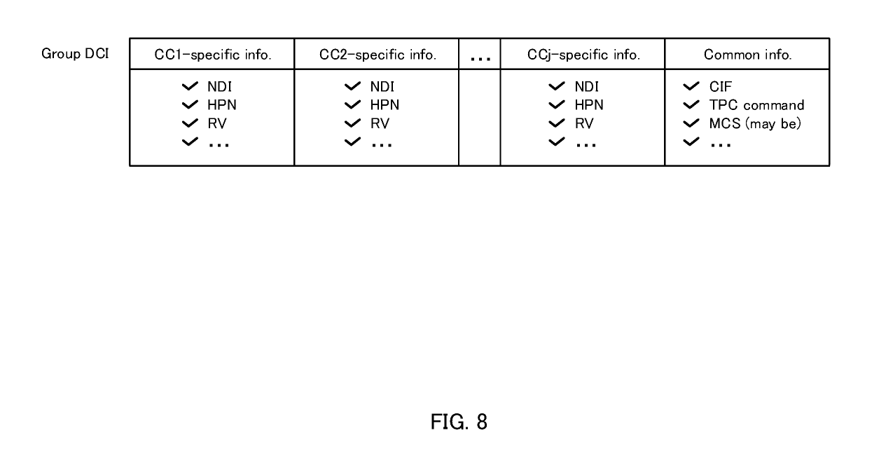

Referring to FIG. 8, in option 4 of the second retransmission control, when data is transmitted in a plurality of carriers simultaneously, the DCIs of these multiple carriers are reported to a user terminal together, by using group DCI, which bundles a plurality of carriers in one group. By this means, it is possible to reduce the overhead, the user terminal's load upon blind decoding, and so on. The group DCI includes the NDI, the HPN and the RV (Redundancy Version) of each carrier. In this case, for example, the HPNs of a plurality of carriers may be made consecutive numbers, as in option 1 of the second retransmission control, so that, when retransmission data is scheduled in a carrier in the group, the user terminal can identify in which HARQ process the past transmission data, the continuing data of which the retransmission data constitutes, has been transmitted. Alternatively, it is possible to expand the NDI field as in option 2 of the second retransmission control, and report which carrier's data the continuing data corresponds to, in the carrier-specific information in the group DCI.

In this way, by employing one of the first and second retransmission controls, it is possible to reduce the retransmission delay even when the channel busy state is produced frequently. Also, since transmission data that has failed to be received no longer needs to be kept in soft buffers, it is possible to improve the efficiency of the use of soft buffers. Furthermore, in each of options 1 to 4 of the second retransmission control, retransmission data is retransmitted in another carrier as continuing data of transmission data, so that it is possible to achieve composite gain.

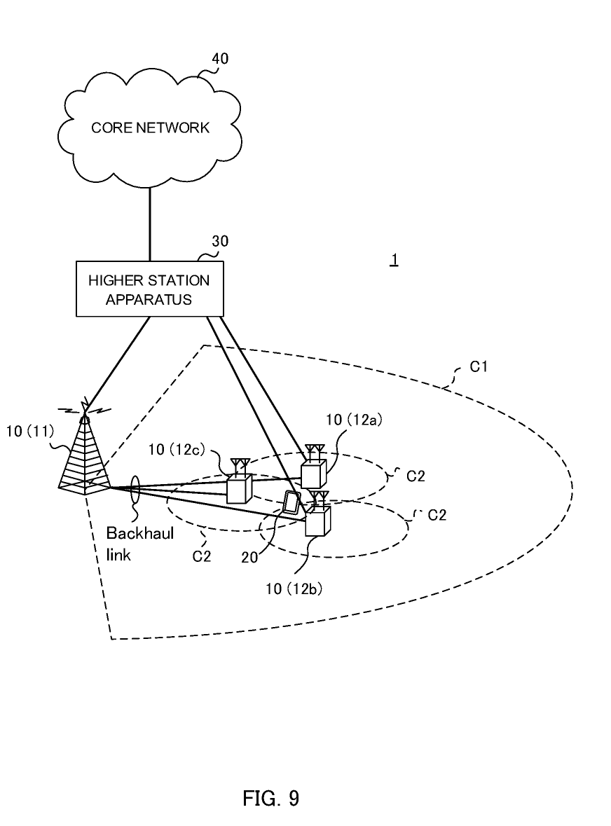

Now, the radio communication system according to the present embodiment will be described in detail. FIG. 9 is a diagram to show a schematic structure of the radio communication system according to the present embodiment. In this radio communication system, a radio communication method to use the above-described first and second retransmission controls is employed. The first and second retransmission controls may be applied individually, or may be applied selectively depending on the situation.

Note that the radio communication system 1 shown in FIG. 9 is a system to incorporate, for example, an LTE system, super 3G, an LTE-A system and so on. The radio communication system 1 can adopt carrier aggregation (CA) and/or dual connectivity (DC) to group a plurality of fundamental frequency blocks (component carriers) into one, where the LTE system bandwidth constitutes one unit. Also, the radio communication system 1 has a radio base station (for example, an LTE-U base station) that is capable of using unlicensed carriers. Note that the radio communication system 1 may be referred to as “IMT-Advanced,” or may be referred to as “4G,” “5G,” “FRA” (Future Radio Access) and so on.

The radio communication system 1 includes a radio base station 11 that forms a macro cell C1, and radio base stations 12a to 12c that form small cells C2, which are placed within the macro cell C1 and which are narrower than the macro cell C1. Also, user terminals 20 are placed in the macro cell C1 and in each small cell C2. For example, a mode may be possible in which the macro cell C1 is used in a licensed carrier and the small cells C2 are used in unlicensed carriers (LTE-U). Also, a mode may be also possible in which part of the small cells is used in a licensed carrier and the rest of the small cells are used in unlicensed carriers.

The user terminals 20 can connect with both the radio base station 11 and the radio base stations 12. Between the user terminals 20 and the radio base station 11, communication is carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Note that the frequency bands for use in each radio base station are by no means limited to these. Between the radio base station 11 and the radio base stations 12 (or between two radio base stations 12), wire connection (optical fiber, the X2 interface, etc.) or wireless connection may be established.

The radio base station 11 and the radio base stations 12 are each connected with a higher station apparatus 30, and are connected with a core network 40 via the higher station apparatus 30. Note that the higher station apparatus 30 may be, for example, an access gateway apparatus, a radio network controller (RNC), a mobility management entity (MME) and so on, but is by no means limited to these. Also, each radio base station 12 may be connected with higher station apparatus 30 via the radio base station 11.

Note that the radio base station 11 is a radio base station having a relatively wide coverage, and may be referred to as a “macro base station,” a “central node,” an “eNB” (eNodeB), a “transmitting/receiving point” and so on. Also, the radio base stations 12 are radio base stations having local coverages, and may be referred to as “small base stations,” “micro base stations,” “pico base stations,” “femto base stations,” “HeNBs” (home eNodeBs), “RRHs” (Remote Radio Heads), “transmitting/receiving points” and so on. Hereinafter the radio base stations 11 and 12 will be collectively referred to as “radio base stations 10,” unless specified otherwise. Also, it is preferable to synchronize radio base stations 10 that use the same unlicensed carrier on a shared basis in time.

The user terminals 20 are terminals to support various communication schemes such as LTE, LTE-A and so on, and may be either mobile communication terminals or stationary communication terminals.

In the radio communication system 1, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier communication scheme to perform communication by dividing a frequency band into a plurality of narrow frequency bands (sub carriers) and mapping data to each sub carrier. SC-FDMA is a single-carrier communication scheme to mitigate interference between terminals by dividing the system band into bands formed with one or continuous resource blocks per terminal, and allowing a plurality of terminals to use mutually different bands. Note that the uplink and downlink radio access schemes are by no means limited to the combination of these.

In the radio communication system 1, a downlink shared channel (PDSCH: Physical Downlink Shared CHannel), which is used by each user terminal 20 on a shared basis, a broadcast channel (PBCH: Physical Broadcast CHannel), downlink L1/L2 control channels and so on are used as downlink channels. User data, higher layer control information and SIBs (System Information Blocks) are communicated in the PDSCH. Also, synchronization signals, MIBs (Master Information Blocks) and so on are communicated by the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI), including PDSCH and PUSCH scheduling information, is communicated by the PDCCH. The number of OFDM symbols to use for the PDCCH is communicated by the PCFICH. HARQ delivery acknowledgement signals (ACKs/NACKs) in response to the PUSCH are communicated by the PHICH. The EPDCCH may be frequency-division-multiplexed with the PDSCH (downlink shared data channel) and used to communicate DCI and so on, like the PDCCH.

In the radio communication system 1, an uplink shared channel (PUSCH (Physical Uplink Shared CHannel)), which is used by each user terminal 20 on a shared basis, an uplink control channel (PUCCH (Physical Uplink Control CHannel)), a random access channel (PRACH (Physical Random Access CHannel)) and so on are used as uplink channels. User data and higher layer control information are communicated by the PUSCH. Also, downlink radio quality information (CQI: Channel Quality Indicator), delivery acknowledgement signals and so on are communicated by the PUCCH. By means of the PRACH, random access preambles for establishing connections with cells are communicated.

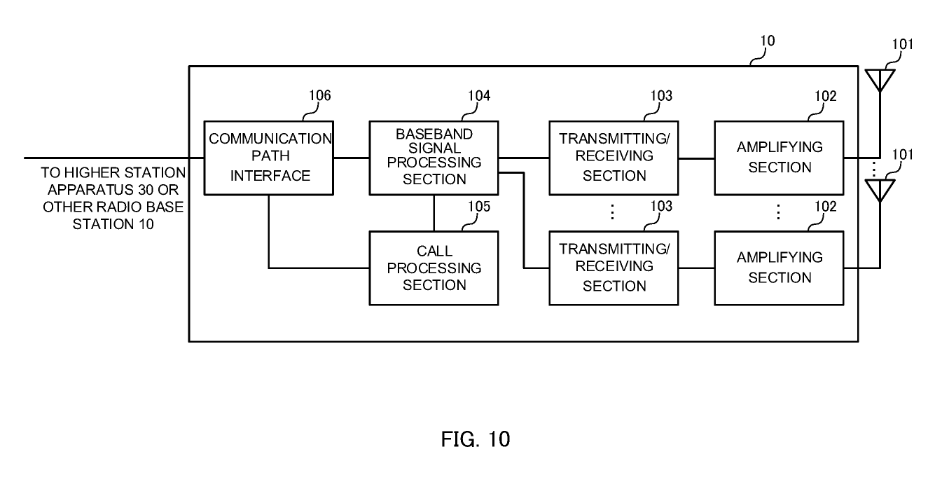

FIG. 10 is a diagram to show an example of an overall structure of a radio base station according to the present embodiment. The radio base station 10 has a plurality of transmitting/receiving antennas 101 for MIMO communication, amplifying sections 102, transmitting/receiving sections 103, a baseband signal processing section 104, a call processing section 105 and a communication path interface 106. Note that the transmitting/receiving sections 103 may be comprised of transmitting sections and receiving sections. Also, although multiple transmitting/receiving antennas 101 are provided here, it is also possible to provide only one.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Also, the baseband signal processing section 104 reports, to the user terminal 20, control information for allowing communication in the cell (system information), through higher layer signaling (for example, RRC signaling, broadcast signals and so on). The information for allowing communication in the cell includes, for example, the system bandwidth on the uplink, the system bandwidth on the downlink, and so on. Also, assist information related to communication in an unlicensed carrier may be transmitted from a radio base station (for example, the radio base station 11) to the user terminal 20 by using a licensed carrier.

Each transmitting/receiving section 103 converts baseband signals that are pre-coded and output from the baseband signal processing section 104 on a per antenna basis, into a radio frequency band. The radio frequency signals having been subjected to frequency conversion in the transmitting/receiving sections 103 are amplified in the amplifying sections 102, and transmitted from the transmitting/receiving antennas 101. For the transmitting/receiving sections 103, transmitters/receivers, transmitting/receiving circuits or transmitting/receiving devices that can be described based on common understanding of the technical field to which the present invention pertains can be used.

Meanwhile, as for uplink signals, radio frequency signals that are received in the transmitting/receiving antennas 101 are each amplified in the amplifying sections 102. Each transmitting/receiving section 103 receives uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base stations 10 and manages the radio resources.

The communication path interface section 106 transmits and receives signals to and from the higher station apparatus 30 via a predetermined interface. Also, the communication path interface 106 may transmit and receive signals (backhaul signaling) to and from other radio base stations 10 (for example, neighboring radio base stations) via an inter-base station interface (for example, optical fiber, the X2 interface, etc.). For example, the communication path interface 106 may transmit and receive information about the subframe configuration that relates to LBT, to and from other radio base station 10.

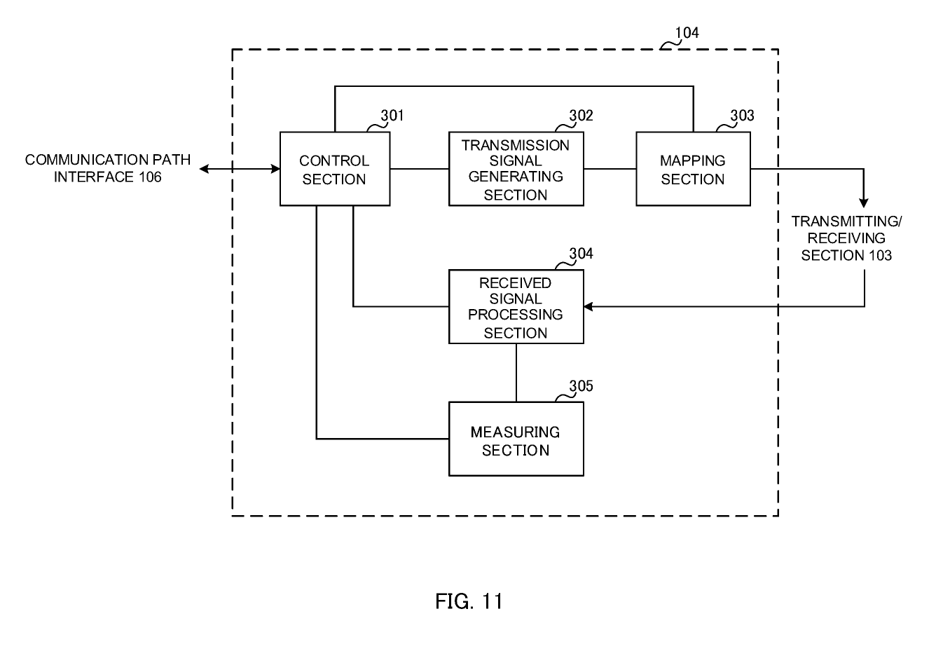

FIG. 11 is a diagram to show an example of a functional structure of a radio base station according to the present embodiment. Note that, although FIG. 11 primarily shows functional blocks that pertain to characteristic parts of the present embodiment, the radio base station 10 has other functional blocks that are necessary for radio communication as well. As shown in FIG. 11, the baseband signal processing section 104 provided in the radio base station 10 has a control section (scheduler) 301, a transmission signal generating section 302, a mapping section 303, and a received signal processing section 304 and a measurement section 305. Note that the mapping section 303 and the transmitting/receiving sections 103 may constitute a transmission section.

The control section (scheduler) 301 controls the scheduling (for example, the resource allocation) of downlink data signals that are transmitted in the PDSCH and downlink control signals that are communicated in the PDCCH and/or the EPDCCH. Also, the control section 301 controls the scheduling of downlink reference signals such as system information, synchronization signals, the CRS (Cell-specific Reference Signal), the CSI-RS (Channel State Information Reference Signal) and so on. Also, the control section 301 controls the scheduling of uplink reference signals, uplink data signals that are transmitted in the PUSCH, uplink control signals that are transmitted in the PUCCH and/or the PUSCH, RA preambles that are transmitted in the PRACH, and so on.

Also, the control section 301 exerts retransmission control in accordance with, for example, the result of LBT in unlicensed carriers. If the result of LBT indicates the idle state, the control section 301 controls the transmission signal generating section 302 and the mapping section 303 to execute retransmission in the same carrier. If the result of LBT indicates the busy state, the control section 301 starts the LBT busy timer, and controls the transmission signal generating section 302 and the mapping section 303 to carry out cross-carrier retransmission if transmission does not succeed before the timer expires. In this case, the control section 301 may exert retransmission control so that retransmission data is retransmitted as new data, or exert retransmission control so that retransmission data is transmitted as continuing data of transmission data. The control section 301 may control retransmission based on information other than LBT results, and may exert retransmission control based on, for example, the situation concerning the traffic load in the carrier, information about the traffic load in other carriers, and so on. For the control section 301, a controller, a control circuit or a control device that can be described based on common understanding of the technical field to which the present invention pertains can be used.

The transmission signal generating section 302 generates DL signals based on commands from the control section 301 and outputs these signals to the mapping section 303. For example, the transmission signal generating section 302 generates DCI (DL assignments) that reports downlink signal allocation information, and DCI (UL grant) that reports uplink signal allocation information. Also, the downlink transmission data is subjected to a coding process and a modulation process, based on coding rates and modulation schemes that are determined based on channel state information (CSI) from each user terminal 20 and so on.

When retransmission data is transmitted as new data, the transmission signal generating section 302 may generate flush information, which commands that past transmission data be flushed from the user terminals' soft buffers (see the first control method in FIG. 4). In the flush information, the carrier indices of carriers where retransmission is not possible are designated. Note that it is also possible to designate HPNs, in addition to carrier indices, in the flush information. Also, when retransmission data is transmitted as continuing data, the transmission signal generating section 302 may generate DCI so as to allow the user terminals to recognize that transmission data that has been transmitted in the past and continuing data that is going to be transmitted are a common HARQ process (see the second control method in FIG. 5 to FIG. 8).

To be more specific, the transmission signal generating section 302 may generate DCI that includes the HPNs of transmission data that is combined with continuing data (see option 1 of the second retransmission control in FIG. 5). In this case, given that continuous HPNs are configured between a plurality of carriers, it is possible to allow the user terminals to recognize the transmission data to be combined with the continuing data based on the HPNs. Note that it is also possible to configure continuous HPNs in licensed carriers and unlicensed carriers, or configure HPNs 0 to 7 in a licensed carrier and configure continuous HPNs from HPN 8 and onwards in a plurality of unlicensed carriers.

Also, the transmission signal generating section 302 may generate DCI, in which the NDI is expanded and indicator bits and HPNs are included (see option 2 of the second retransmission control in FIG. 6). The indicator bits can identify whether retransmission data is new transmission data or continuing data, and in which carrier the transmission data to which continuing data corresponds has been transmitted. In this case, the smallest number among the HPNs of carriers that cannot be used for retransmission may be mapped to an unoccupied HPN of a carrier that can be used for cross-carrier retransmission, which is reported with the NDI. By this means, it is possible to allow the user terminals 20 to recognize the mapping relationship between transmission data and retransmission data without reporting the relationship in mapping to the user terminals 20. Also, it is possible to use HPNs that are unoccupied in carriers that can be used for cross-carrier retransmission, in retransmission in the HPNs of carriers where retransmission is not possible, so that it is possible to make effective use of the soft buffers of the user terminals 20.

Also, the transmission signal generating section 302 may generate DCI that includes the combination of the reference source carrier index and an HPN, and the combination of the referring carrier index and an HPN (see option 3 of the second retransmission control in FIG. 7). By this means, it is possible to allow the user terminals to recognize the mapping relationship between the transmission data of the reference source carrier and retransmission data of the referring carrier. In this case, it is possible to generate DCI in DCI format 1C, and scramble this by using user-specific C-RNTIs and/or the like.

Also, the transmission signal generating section 302 may generate group DCI, in which a plurality of carriers are made one group (see option 4 of the second retransmission control in FIG. 8). The group DCI is generated to include HPNs, which show the mapping relationship between continuing data and transmission data per carrier in the group. In this case, it is possible to configure continuous HPNs between a plurality of carriers, as in option 1 of the second retransmission control (see FIG. 5), and allow the user terminals to identify the transmission data to be combined with continuing data, based on the HPNs. It is possible to configure continuous HPNs in licensed carriers and unlicensed carriers, or configure HPNs 0 to 7 in a licensed carrier and configure continuous HPNs from HPN 8 and onwards in a plurality of unlicensed carriers. Also, as in option 2 of the second retransmission control (see FIG. 6), in group DCI, NDI-expanding indicator bits and an HPN may be included per carrier in the group. For the transmission signal generating section 302, a signal generator, a signal generating circuit or a signal generating device that can be described based on common understanding of the technical field to which the present invention pertains can be used.

The mapping section 303 maps the downlink signals generated in the transmission signal generating section 302 to radio resources based on commands from the control section 301, and outputs these to the transmitting/receiving sections 103. When cross-carrier retransmission is executed, the mapping section 303 maps the retransmission data to a different carrier from that of the transmission data. For the mapping section 303, mapper, a mapping circuit or a mapping device that can be described based on common understanding of the technical field to which the present invention pertains can be used.

The received signal processing section 304 performs receiving processes (for example, demapping, demodulation, decoding and so on) of received signals that are input from the transmitting/receiving sections 103. Here, the received signals are, for example, UL signals transmitted from the user terminals 20. The received signal processing section 304 outputs the received information to the control section 301. Also, the received signal processing section 304 outputs the received signals, the signals after the receiving processes and so on, to the measurement section 305. For the received signal processing section 304, a signal processor/measurer, a signal processing/measurement circuit or a signal processing/measurement device that can be described based on common understanding of the technical field to which the present invention pertains can be used.

The measurement section 305 measures the traffic-load condition of each carrier based on commands from the control section 301, and commands cross-carrier retransmission to the control section 301 based on the measurement results. The measurement section 305 may, for example, execute LBT in unlicensed carriers, and output the results of LBT (for example, decisions as to whether the channel state is clear or busy) to the control section 301. For the measurement section 305, a measurer, a measurement circuit or a measurement device that can be described based on common understanding of the technical field to which the present invention pertains can be used.

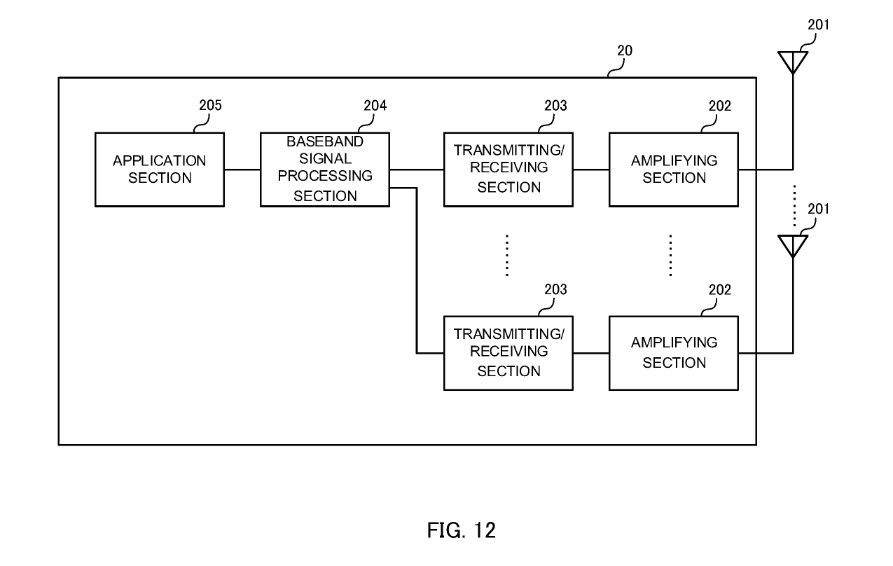

FIG. 12 is a diagram to show an example of an overall structure of a user terminal according to the present embodiment. A user terminal 20 has a plurality of transmitting/receiving antennas 201 for MIMO communication, amplifying sections 202, transmitting/receiving sections 203, a baseband signal processing section 204 and an application section 205. Note that the transmitting/receiving sections 203 may be comprised of transmission sections and receiving sections. Also, although multiple transmitting/receiving antennas 201 are provided here, it is also possible to provide only one.

Radio frequency signals that are received in a plurality of transmitting/receiving antennas 201 are each amplified in the amplifying sections 202. Each transmitting/receiving section 203 receives the downlink signals amplified in the amplifying sections 202. The received signals are subjected to frequency conversion and converted into the baseband signal in the transmitting/receiving sections 203, and output to the baseband signal processing section 204. For the transmitting/receiving sections 203, transmitters/receivers, transmitting/receiving circuits or transmitting/receiving devices that can be described based on common understanding of the technical field to which the present invention pertains can be used.

In the baseband signal processing section 204, the baseband signals that are input are subjected to an FFT process, error correction decoding, a retransmission control receiving process, and so on. Downlink user data is forwarded to the application section 205. The application section 205 performs processes related to higher layers above the physical layer and the MAC layer. Furthermore, in the downlink data, broadcast information is also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, pre-coding, a discrete Fourier transform (DFT) process, an IFFT process and so on, and the result is forwarded to each transmitting/receiving section 203. The baseband signal that is output from the baseband signal processing section 204 is converted into a radio frequency band in the transmitting/receiving sections 203. The radio frequency signals that are subjected to frequency conversion in the transmitting/receiving sections 203 are amplified in the amplifying sections 202, and transmitted from the transmitting/receiving antennas 201.

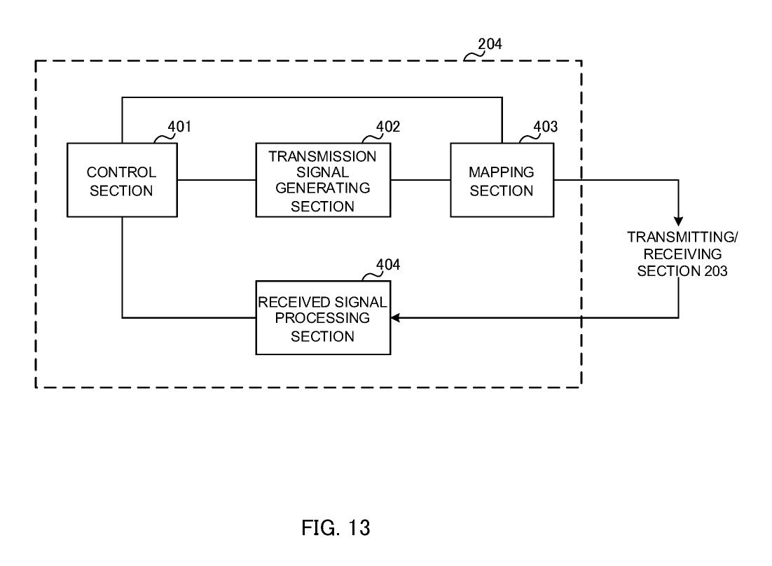

FIG. 13 is a diagram to show an example of a functional structure of a user terminal according to the present embodiment. Note that, although FIG. 13 primarily shows functional blocks that pertain to characteristic parts of the present embodiment, the user terminal 20 has other functional blocks that are necessary for radio communication as well. As shown in FIG. 13, the baseband signal processing section 204 provided in the user terminal 20 has a control section 401, a transmission signal generating section 402, a mapping section 403 and a received signal processing section 404. Note that the received signal processing section 404 and the transmitting/receiving section 203 may constitute a receiving section.

The control section 401 acquires the downlink control signals (signals transmitted in the PDCCH/EPDCCH) and downlink data signals (signals transmitted in the PDSCH) transmitted from the radio base station 10, from the received signal processing section 404. Also, the control section 401 controls the generation of uplink control signals (for example, delivery acknowledgement signals (HARQ-ACKs) and so on) and uplink data signals based on the downlink control signals, the results of deciding whether or not retransmission control is necessary for the downlink data signals, and so on. To be more specific, the control section 401 controls the transmission signal generating section 402 and the mapping section 403.

Based on commands from the radio base station 10, the control section 401 controls the received signal processing section 404 to use, among a plurality of carriers, a carrier that is different from the carrier that has been used for transmission data, and receive retransmission data of this transmission data. In this case, the control section 401 may control receipt such that the retransmission data is received as new data, or control receipt such that the retransmission data is received as continuing data of the transmission data. For example, if the retransmission data is received as new transmission data, the control section 401 may exert control to flush the past transmission data stored in buffers, based on flush information that is reported from the radio base station 10 (see the first retransmission control in FIG. 4).

Also, if the retransmission data is received as continuing data, the control section 401 may exert control to receive the continuing data in a carrier that is different from the carrier in which the transmission data has been transmitted, based on DCI that is reported from the radio base station 10 (see the second retransmission control in FIG. 5 to FIG. 8). In the DCI, the HPN of the transmission data to be combined with the continuing data may be included (see option 1 of the second retransmission control in FIG. 5). In this case, since continuous HPNs are configured between a plurality of carriers, the transmission data to be combined with the continuing data is specified from the HPN, and the past transmission data specified by the HPN is combined with the continuing data.

Also, in the DCI, indicator bits, which are an expanded NDI, and an HPN, may be included (see option 2 of the second retransmission control in FIG. 6). In this case, the indicator bits identify whether new transmission data is transmitted or continuing data is transmitted. Then, if continuing data is identified from the indicator bits, the past transmission data that is specified based on the HPN is combined with the continuing data. In this case, the HPNs of the carrier that has been used for the past transmission data may be mapped to the HPNs of the carrier to be used for the retransmission data. By this means, by specifying unoccupied HPNs, it is possible to combine the past transmission data that is mapped to the unoccupied HPN, with continuing data.

Also, the DCI may include the combination of the reference source carrier index and an HPN, and the combination of the referring carrier index and an HPN (see option 3 of the second retransmission control in FIG. 7). The DCI is generated in DCI format 1C, and de-scrambled by using user-specific C-RNTIs and/or the like. In this case, the past transmission data that is indicated by the reference source carrier's HPN is combined with the continuing data that is indicated by the referring carrier's HPN.

Also, the DCI may be group DCI, in which pluralities of carriers are made one group. The group DCI includes HPNs, which show the mapping relationship between continuing data and transmission data, per carrier in the group. In this case, it is possible to configure continuous HPNs between pluralities of carriers that transmit continuing data, as in option 1 of the second retransmission control (see FIG. 5). By this means, the transmission data to be combined with continuing data is specified based on an HPN, and the past transmission data specified based on the HPN is combined with the continuing data. Also, as in option 2 of the second retransmission control (see FIG. 6), in the group DCI, indicator bits, which are an expanded NDI, and an HPN, may be included per carrier in the group. If continuing data is identified from the indicator bits, the past transmission data that is specified based on the HPN is combined with the continuing data. For the control section 401, a controller, a control circuit or a control device that can be described based on common understanding of the technical field to which the present invention pertains can be used.

The transmission signal generating section 402 generates UL signals (uplink control signals, uplink data signals, uplink reference signals and so on) based on commands from the control section 401, and outputs these signals to the mapping section 403. For example, the transmission signal generating section 402 generates uplink control signals such as delivery acknowledgement signals (HARQ-ACKs), channel state information (CSI) and so on, based on commands from the control section 401. Also, the transmission signal generating section 402 generates uplink data signals based on commands from the control section 401. For the transmission signal generating section 402, a signal generator, a signal generating circuit or a signal generating device that can be described based on common understanding of the technical field to which the present invention pertains can be used.

The mapping section 403 maps the uplink signals generated in the transmission signal generating section 402 to radio resources based on commands from the control section 401, and output the result to the transmitting/receiving sections 203. For the mapping section 403, mapper, a mapping circuit or a mapping device that can be described based on common understanding of the technical field to which the present invention pertains can be used.

The received signal processing section 404 performs receiving processes (for example, demapping, demodulation, decoding and so on) of received signals that are input from the transmitting/receiving sections 203. Here, the received signals are, for example, DL signals transmitted from the radio base station 10 (such as downlink control signals, downlink data signals transmitted in the PDSCH, and so on). The received signal processing section 404 outputs the received information to the control section 401. For the received signal processing section 404, a signal processor/measurer, a signal processing/measurement circuit or a signal processing/measurement device that can be described based on common understanding of the technical field to which the present invention pertains can be used. The received signal processing section 404 can constitute the receiving section according to the present invention.

Note that the block diagrams that have been used to describe the above embodiments show blocks in functional units. These functional blocks (components) may be implemented in arbitrary combinations of hardware and software. Also, the means for implementing each functional block is not particularly limited. That is, each functional block may be implemented with one physically-integrated device, or may be implemented by connecting two physically-separate devices via radio or wire and using these multiple devices.

For example, part or all of the functions of radio base stations 10 and user terminals 20 may be implemented using hardware such as ASICs (Application-Specific Integrated Circuits), PLDs (Programmable Logic Devices), FPGAs (Field Programmable Gate Arrays), and so on. Also, the radio base stations 10 and user terminals 20 may be implemented with a computer device that includes a processor (CPU), a communication interface for connecting with networks, a memory and a computer-readable storage medium that holds programs. That is, the radio base station, user terminal and so on according to the embodiments of the present invention may each function as a computer that executes the processes in the radio communication method according to the present invention.

Here, the processor, the memory and/or others are connected with a bus for communicating information. Also, the computer-readable recording medium is a storage medium such as, for example, a flexible disk, an opto-magnetic disk, a ROM (Read Only Memory), an EPROM (Erasable Programmable ROM), a CD-ROM (Compact Disc-ROM), a RAM (Random Access Memory), a hard disk and so on. Also, the programs may be transmitted from the core network 40 through, for example, electric communication channels. Also, the radio base stations 10 and user terminals 20 may include input devices such as input keys and output devices such as displays.

The functional structures of the radio base stations 10 and user terminals 20 may be implemented with the above-described hardware, may be implemented with software modules that are executed on the processor, or may be implemented with combinations of both. The processor controls the whole of the user terminals by running an operating system. Also, the processor reads programs, software modules and data from the storage medium into the memory, and executes various types of processes.

Here, the programs have only to be programs that make a computer execute processing that has been described with the above embodiments. For example, the control section 401 of the user terminals 20 may be stored in the memory and implemented by a control program that operates on the processor, and other functional blocks may be implemented likewise.

Now, although the present invention has been described in detail above, it should be obvious to a person skilled in the art that the present invention is by no means limited to the embodiments described herein. For example, the above-described embodiments may be used individually or in combinations. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

The disclosure of Japanese Patent Application No. 2015-080326, filed on Apr. 9, 2015, including the specification, drawings and abstract, is incorporated herein by reference in its entirety.

1. A user terminal that can communicate with a radio base station by using a plurality of cells, the user terminal comprising:
a receiving section that receives transmission data from the radio base station; and
a control section that controls a receiving process in the receiving section based on a command that is reported from the radio base station by using an HARQ (Hybrid Automatic Repeat reQuest) process,
wherein, among the plurality of cells, the control section controls the receiving section to use a second cell, which is different from a first cell that has been used to transmit the transmission data from the radio base station, to receive retransmission data of the transmission data.

2. The user terminal according to claim 1, wherein the control section controls the receiving section to receive the retransmission data from the radio base station as new transmission data that is transmitted in the second cell, and controls the receiving section to flush transmission data that is held in a soft buffer based on flush information that is reported from the radio base station.

3. The user terminal according to claim 1, wherein the control section controls the receiving section to receive the retransmission data from the radio base station in the second cell as continuing data of the transmission data transmitted in the first cell.

4. The user terminal according to claim 3, wherein:
the control section controls the receiving section to receive the continuing data in the second cell based on downlink control information that is reported from the radio base station; and
the downlink control information specifies the first cell in which the transmission data has been transmitted, and a retransmission control process number of the transmission data to be combined with the continuing data.

5. The user terminal according to claim 4, wherein:
in the first cell and the second cell, retransmission control process numbers that are continuous between the cells are configured; and
in the downlink control information, a retransmission control process number of the transmission data to be combined with the continuing data is included.

6. The user terminal according to claim 5, wherein, in the downlink control information, a plurality of second cells are made one group, and, for every second cell in the group, a retransmission control process number of transmission data to be combined with continuing data is included.

7. The user terminal according to claim 4, wherein the downlink control information includes an indicator bit and a retransmission control process number, the indicator bit identifying whether retransmission data is new transmission data or continuing data, and identifying in which cell transmission data to which continuing data corresponds has been transmitted.

8. The user terminal according to claim 4, wherein the downlink control information includes a combination of a first cell, in which transmission data is transmitted, and a retransmission control process number, and a combination of a second cell, in which continuing data is transmitted, and a retransmission control process number.

9. A radio base station that can communicate with a user terminal by using a plurality of cells, the radio base station comprising:
a transmission section that transmits transmission data to the user terminal; and
a generating section that generates command information for controlling a receiving process of the user terminal by using an HARQ (Hybrid Automatic Repeat reQuest) process,
wherein, among the plurality of cells, the transmission section transmits retransmission data of the transmission data in a second cell, which is different from a first cell that has been used to transmit the transmission data, and makes the user terminal receive the retransmission data by using the command information.

10. A radio communication method for allowing a user terminal and a radio base station by using a plurality of cells, the radio communication method comprising the steps in which:
the radio base station transmits transmission data to the user terminal;
the radio base station transmits command information for controlling a receiving process of the user terminal, to the user terminal, by using an HARQ (Hybrid Automatic Repeat reQuest) process, and transmits retransmission data of the transmission data in a second cell, among the plurality of cells, which is different from a first cell that has been used to transmit the transmission data; and
the user terminal receives the retransmission data in the second cell in accordance with the command information from the radio base station.
